(19) United States
(12) Patent Application Publication
(10) Pub. No.: US 2010/0023876 A1
(43) Pub. Date: Jan. 28, 2010

(54) System and Method for Reducing Bandwidth Requirements of a Presentation Transmitted Across a Network

(75) Inventors: Yefim Shuf, Millwood, NY (US); Alex Zlatsin, Yorktown Heights, NY (US); Dimitri Kanevsky, Ossining, NY (US); Genady Grabarnik, Scarsdale, NY (US)

Correspondence Address: CONNOLLY BOVE LODGE & HUTZ LLP, 1875 EYE STREET, N.W., SUITE 1100, WASHINGTON, DC, 20006, US

(73) Assignee: International Business Machines Corporation, Armonk, NY (US)

(21) Appl. No.: 12/180,678

(22) Filed: Jul. 28, 2008

(51) Int. Cl. G06F 3/00

(52) U.S. Cl. 715/753

(57) ABSTRACT

An apparatus and method for reducing network bandwidth requirements associated with presentations transmitted over a network is disclosed. The method includes receiving information associated with a presentation at a remote site, and connecting to an on-line conference and accessing the presentation. The method also includes during the presentation, receiving control commands at the remote site, converting the control commands into navigation commands for controlling screen displays of the presentation at the remote site, and executing the navigation commands in a presentation software tool at the remote location to view information associated with the presentation.

### BACKGROUND OF THE INVENTION

1. Field of the Invention

This invention relates to the field of on-line conferencing, and particularly to an apparatus and method for reducing the bandwidth requirements associated with transmitting a presentation across a network.

2. Description of the Related Art

Various net meeting software tools enable a presenter to share a screen displaying a presentation with remote participants during an on-line conference. An example of a net meeting tool may be IBM Web Meeting™ or Microsoft Net Meeting™. The presentation is usually presented to the participants through a presentation software tool, such as Microsoft Power Point™, Lotus Freelance™ or Adobe Acrobat Reader™, installed on the presenter's computer and viewed by the participants through a presentation software tool installed on each participant's computer. The net meeting software tools typically broadcast the entire contents of the presenter's screen to the participants during the on-line conference.

Whenever the contents of presenter's screen change, which can happen as a result of moving to another page in the presentation, the changed contents of presenter's screen is broadcast to all participants of the net meeting to ensure synchronization of the presentation on the participant's screen with the presentation on the presenter's screen. The amount of information associated with a computer screen may be on the order of several megabytes. Sending large amounts of information to many participants may cause congestion on a network which may delay the updating of the participant's screen and/or prevent a participant from viewing the presentation over a relatively low bandwidth wireless connection. Sending large amounts of information to many participants may also reduce periodicity. Furthermore, the resolution of a participant's screen may be smaller than the resolution on the presenter's screen which may lead to distortion of the presentation on the participant's screen.

Hence, there is a need to reduce the amount of information that is required to be transferred from the presenter's computer to participants' computers during an on-line conference and thereby, reduce the bandwidth requirements associated with on-line presentations.

### SUMMARY OF INVENTION

The present invention is directed to an apparatus and method for reducing the bandwidth requirements associated with transmitting a presentation across a network. The method includes receiving information associated with a presentation at a remote site. The method also includes connecting to an on-line conference and accessing the presentation. The method further includes during the presentation, receiving control commands at the remote site, converting the control commands into navigation commands for controlling screen displays of the presentation at the remote site and executing the navigation commands in a presentation software tool at the remote location to view information associated with the presentation.

Another embodiment of the invention is directed to an apparatus including a receiving unit configured to receive information associated with a presentation at a remote site and a connecting unit configured to connect to an on-line conference and access the presentation. The apparatus also includes a receiving unit configured to receive control commands at the remote site and a converting unit configured to convert the control commands into navigation commands for controlling screen displays of the presentation at the remote site. The apparatus also includes an executing unit configured to execute the navigation commands in a presentation software tool at the remote location to view information associated with the presentation.

Another embodiment of the invention is directed to an apparatus including a transmitting unit configured to transmit information associated with a presentation to a plurality of remote sites and a connecting unit configured to connect to an on-line conference and access the presentation. The apparatus also includes a presentation unit configured to present and control screen displays of the presentation and a synchronization unit configured to synchronize presentation actions with navigation commands for controlling screen displays associated with the presentation. The apparatus further includes a conversion unit configured to convert navigation commands into control instructions and a transmission unit configured to transmit the control instructions to the plurality of remote sites. At each of the plurality of remote sites, the control instructions are converted into navigation commands for controlling screen displays of the presentation at the remote site.

Another embodiment of the invention is directed to a computer program embodied on a computer readable medium, the computer program comprises program code for controlling a processor to execute a method comprising receiving information associated with a presentation at a remote site; connecting to an on-line conference and accessing the presentation; during the presentation, receiving control commands at the remote site; converting the control commands into navigation commands for controlling screen displays of the presentation at the remote site; and executing the navigation commands in a presentation software tool at the remote location to view information associated with the presentation.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an example of a network in which an embodiment of the invention may be implemented;

FIG. 2 illustrates an embodiment of the slide synchronizer;

FIG. 3 illustrates the activities and functions implemented at a participant's site;

FIG. 4 illustrates the activities and functions implemented at the mail server; and

FIG. 5 illustrates the steps implemented in an embodiment of the invention.

### DETAILED DESCRIPTION OF EMBODIMENTS OF THE INVENTION

Embodiments in which the present invention is applied to an apparatus and method for reducing the bandwidth requirements associated with viewing a presentation across a network is described in detail below with reference to the accompanying drawings.

In an embodiment of the invention, prior to starting an on-line conference, a copy of the presentation to be viewed during the on-line conference is transmitted to the remote and/or local participants. The copy of the presentation may be transmitted, for example as an attachment, from the presenter to the participants. The transmission of the presentation may also include the scheduled presentation time, the presenter connection information, along with the usual on-line conferencing information, such as a dial-in phone number, a URL or a network address. Alternatively, prior to starting the on-line conference, the presentation may be downloaded by the participants along with the usual on-line conferencing information.

Thereafter, the presenter and participants connect to the on-line conference. For example, the presenter and participants may connect to the on-line conference by either dialing in to an assigned number for the on-line conference or by logging in to an associated web-site.

The presenter and the participants may use an associated presentation software tool to open the presentation. The presenter thereafter presents and controls the presentation through the presentation software tool on the presenter's computer. For example, the presenter may use the presentation software tool to change pages during the presentation. During the presentation, the presenter's mouse and keyboard navigation functions are converted into control commands which are sent from presenter's presentation software tool via the net meeting software to the participants' presentation software tools. Upon receipt of the control commands at the participants' sites, the control commands are converted into automated mouse and keyboard navigation commands in the participants' presentation software tools for controlling the display screen on the participants' computers. Because control commands are considerably smaller than the contents of an entire screen, the network bandwidth requirement for the presentation is reduced considerably.

In an embodiment of the invention, synchronization may occur between the screen being presented by a presenter and the screens that are being viewed by the participants. For example, a remote participant may decide to review one or more previous presentation screens during the presentation. During the review by the participant, incoming commands from the presenter are stored in a buffer. To return the participant to the display screen that was being viewed prior to the review, the buffered commands may then be executed. In one embodiment, the buffered commands may be executed at a relatively faster speed than the speed for updating the presentation screens at the remote site in order to synchronize the screen being viewed by the remote participant with the current display screen being presented by the presenter.

A remote participant may use an automatic speech recognizer to execute the navigation commands that are transmitted by the presenter. For example, if the presenter issues a voice instruction to “move to slide 5”, upon receipt of that control command from the presenter, the remote automatic speech recognizer converts the speech control commands to navigation control commands in the participants' presentation software tools, for controlling the screen on the participants' computers. Upon completion of the presentation, the on-line conference may be terminated.

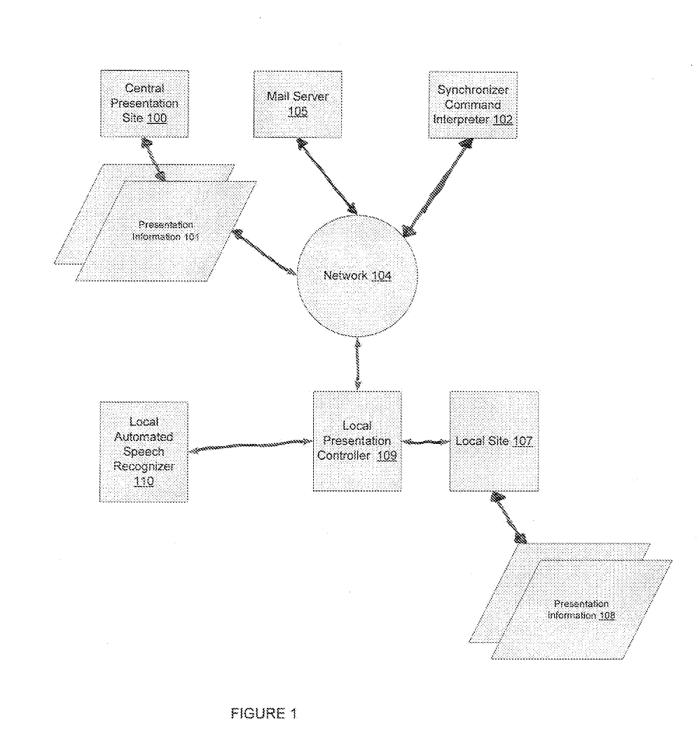

FIG. 1 illustrates an example of a network in which an embodiment of the invention may be implemented. The network includes a mail server 105 which is configured to send presentation information, for example presentation slides 101 or a URL associated with the presentation, to a central presentation site 100. It should be noted that while this embodiment of the invention uses a central presentation site, a central presentation site is not required to implement the invention. Therefore, one of ordinary skill in the art will readily appreciate that central presentation site 100 is an optional implementation in an embodiment of the invention. At central presentation site 100, presentation information is transmitted to a list of remote and/or local participants of the on-line conference. A local presentation controller 109 at each of a plurality of remote and/or local sites is configured to receive the presentation information and is configured to store the received information 108 locally, for example at site 107. A synchronizer command interpreter 102 is configured to synchronize the presentation for all participants of the on-line conference. For example, if a remote participant decides to move to another point in the presentation, synchronizer command interpreter 102 may be used to return the participant to the current page of the presentation. In an embodiment of the invention, if a remote participant moves to another point in the presentation, presentation commands given by the local presentation controller 109 may be buffered and used at a later time to return the participant to the current page of the presentation. The local presentation controller 109 is also configured to use a local automatic speech recognizer 110 to execute voice commands that are transmitted from the central presentation site.

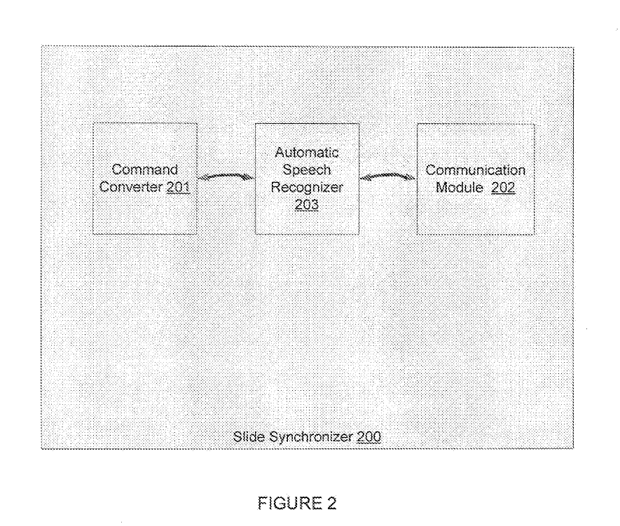

FIG. 2 illustrates a slide synchronizer implemented in an embodiment of the invention. Slide synchronizer 200 allows for the synchronization of presenter actions with commands that change slides or show items in a slide, for example keyboard or mouse movements on the slide. A command converter 201 is configured to convert navigation function to command instructions. Slide synchronizer 200 is further configured to interpret voice commands in automatic speech recognizer 203. Communication module 202 is configured to transmit and receive signals, including command instructions, across network.

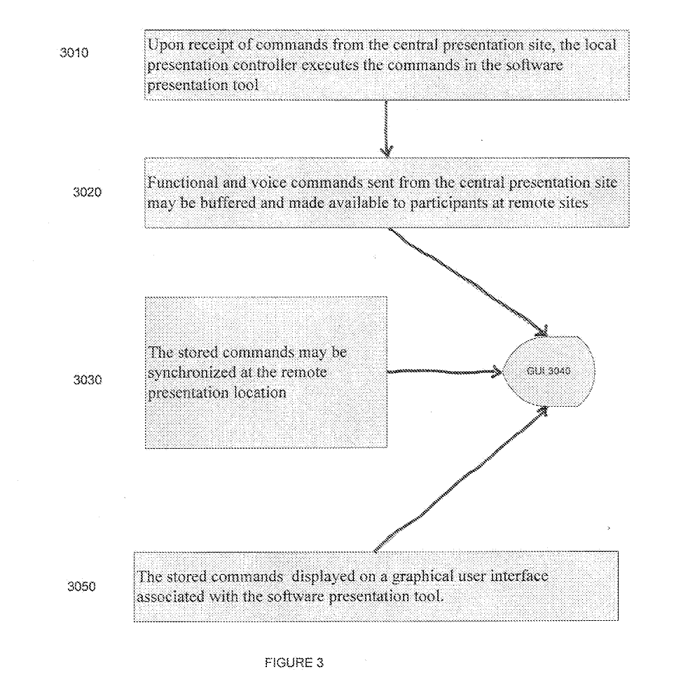

FIG. 3 illustrates the activities and functions implemented at each of the plurality of remote sites. In 3010, upon receipt of commands from central presentation site 100 or one or more other remote locations, local presentation controller 109 executes the commands in the software presentation tool. In 3020, functional and voice commands sent from the central presentation site 100 may be buffered and made available to participants at remote sites. These commands may be made available to participants with low bandwidth connections or to participants who are reviewing other parts of the presentation. In 3030, the stored commands may be synchronized at the remote presentation location and later displayed on a graphical user interface 3040 associated with the software presentation tool. A speed controller may be presented for mediating the speed for displaying the buffered content, as shown in 3050. For example, if a participant is behind in the presentation, the buffered content may be displayed at a relatively faster rate so that the participant's screen at the remote presentation location can be synchronized with the current presentation status at the central presentation site.

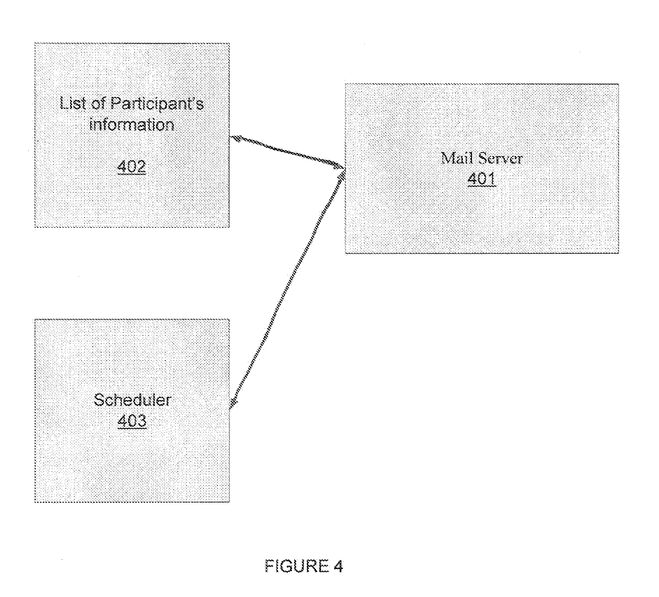

FIG. 4 illustrates functions and activities implemented at the mail server. The mail server 105 mediates the delivery and scheduling of presentations to participants on the network. A scheduler 403 is connected to a mail system 400 and a list of participant's contact information addresses 402 are accessibly by mail server 105. At a predetermined time, as indicated by the scheduler 403, the presentation is sent to the participants associated with the contact information.

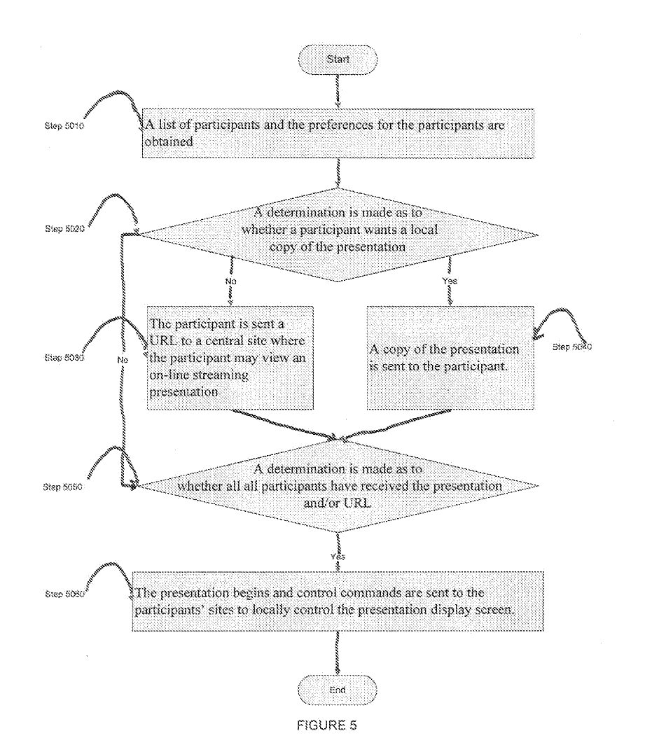

FIG. 5 illustrates the steps implemented in an embodiment of the invention. In Step 5010, a list of participants and the preferences for the participants are obtained. The participants' preferences may include a required file format for receiving the presentation and an associated e-mail account. The participants' preferences may also include other preferences, such as visual preferences for example a color schemes. In Step 5020, a determination is made as to whether a participant wants a local copy of the presentation. If the participant does not want a local copy of the presentation, in Step 5030, the participant is sent a URL to a central site where the participant may view an on-line streaming presentation. If the participant does want a local copy of the presentation, in Step 5040, a copy of the presentation is sent to the participant.

In the alternative, the presentation may be posted on-line for early downloading and an announcement including the URL for downloading the presentation may be sent to all participants. In Step 5050, a determination is made as to whether all participants have received the presentation and/or URL. If some participants have not received at least one of the presentation or URL, the process returns to step 5020. If all participants have received at least one of the presentation or URL, at the scheduled time, in Step 5060, the presentation begins and control commands are sent to the participants' sites to locally control the presentation display screens.

It should be noted that each of the units and one or more of the sub-units listed in embodiments of the invention include standard computer processing components that are known to one of ordinary skill in the art. For example, each of mail server 105, slide synchronizer 200, and presentation controller 109 includes at least one of a processor or a storage device. It should also be noted that one or more units noted in the embodiments above may be coupled. For example, mail server 105 and synchronizer command interpreter 102 may be coupled to at least one of the central presentation site 100 or local presentation controller 109.

In an embodiment of the invention, the presenter may specify what participants can do with the presentation and which parts of the presentation may be edited, saved and/or copied. For example, the presenter's notes may or may not be seen by the participants.

Although the present invention has been shown and described with respect to certain embodiments, it should be understood by those skilled in the art that various modifications can be made to the inventive apparatus and the method of the instant invention without departing from the scope and spirit of the invention. It is intended that the present invention cover modifications and variations of the inventive testing device and method provided they come within the scope of the appended claims and their equivalents.

What is claimed:

1. A method, comprising:
receiving information associated with a presentation at a remote site;
connecting to an on-line conference and accessing the presentation;
during the presentation, receiving control commands at the remote site;
converting the control commands into navigation commands for controlling screen displays of the presentation at the remote site; and
executing the navigation commands in a presentation software tool at the remote site to view information associated with the presentation during the on-line conference.

2. The method of claim 1, wherein receiving information comprises receiving at least one of an attachment including the presentation, a scheduled presentation time, connection information associated with a presenter, or on-line conferencing information.

3. The method of claim 1, wherein receiving information comprises receiving downloading information for downloading the presentation.

4. The method of claim 1, wherein the control commands comprise navigation commands executed in a presentation software tool at another location and transmitted over a network to the remote site.

5. The method of claim 1, wherein accessing the presentation comprises viewing the presentation through the presentation software tool which is executed at the remote site.

6. The method of claim 1, comprising:
moving to a presentation display screen which is different from a current presentation display screen being presented by a presenter at a different location;
buffering incoming control commands at the remote site; and
executing the buffered control commands in order to return to a display screen that was being viewed prior to the moving.

7. The method of claim 6, wherein the executing comprises executing the buffered control commands at a rate faster than a rate for executing display screens during the presentation.

8. The method of claim 1, comprising using an automatic speech recognizer to execute voice navigation commands in the presentation software tool at the remote location.

9. An apparatus, comprising:
a receiving unit configured to receive information associated with a presentation at a remote site;
a connecting unit configured to connect to an on-line conference and access the presentation;
a receiving unit configured to receive control commands at the remote site;
a converting unit configured to convert the control commands into navigation commands for controlling screen displays of the presentation at the remote site; and
an executing unit configured to execute the navigation commands in a presentation software tool at the remote site to view information associated with the presentation during the on-line conference.

10. The apparatus of claim 9, wherein the receiving unit configured to receive at least one of an attachment including the presentation, a scheduled presentation time, connection information associated with a presenter, or on-line conferencing information.

11. The apparatus of claim 9, wherein the receiving unit configured to receive downloading information for downloading the presentation.

12. The apparatus of claim 9, wherein the control commands comprise navigation commands executed in a presentation software tool at another location and transmitted over a network to the remote site.

13. The apparatus of claim 9, wherein the apparatus is coupled to a synchronization unit which is configured to synchronize the presentation display at a plurality of remote sites.

14. The apparatus of claim 9, further comprising:
a navigation unit to enable movement to a presentation display screen which is different from a current presentation display screen being presented by a presenter at a different location;
a buffering unit to buffer incoming control commands at the remote site; and
an executing unit to execute the buffered control commands in order to return to a display screen that was being viewed prior to the movement.

15. The apparatus of claim 14, wherein the executing unit is configured to execute the buffered control commands at a rate faster than a rate for executing display screens during the presentation.

16. The apparatus of claim 9, wherein the apparatus is coupled to an automatic speech recognizer to execute voice navigation commands in the presentation software tool at the remote location.

17. An apparatus, comprising:
a transmitting unit configured to transmit information associated with a presentation to a plurality of remote sites;
a connecting unit configured to connect to an on-line conference and access the presentation;
a presentation unit configured to present and control screen displays of the presentation;
a synchronization to synchronize actions with navigation commands for controlling screen displays;
a conversion unit configured to convert navigation commands into control instructions; and
a transmission unit configured to transmit the control instructions to a plurality of remote sites,
wherein at each of the plurality of remote sites, the control instructions are converted into navigation commands for controlling screen displays of the presentation at the remote site and the navigation commands are executed in a presentation software tool at the remote site to view information associated with the presentation during the on-line conference.

18. The apparatus of claim 17, wherein the transmitting unit comprises a mail server to mediate delivery and scheduling of presentations to the plurality of remote sites.

19. A computer program embodied on a computer readable medium, the computer program comprises program code for controlling a processor to execute a method comprising:
receiving information associated with a presentation at a remote site;
connecting to an on-line conference and accessing the presentation;
during the presentation, receiving control commands at the remote site;
converting the control commands into navigation commands for controlling screen displays of the presentation at the remote site; and
executing the navigation commands in a presentation software tool at the remote site to view information associated with the presentation during the on-line conference.
